(19) United States
(12) Patent Application Publication
(10) Pub. No.: US 2024/0291095 A1
(43) Pub. Date: Aug. 29, 2024

(54) MODULE CONNECTION SYSTEM FOR ENERGY STORAGE SYSTEMS

(71) Applicant: HARTING ELECTRIC STIFTUNG & CO. KG, Espelkamp (DE)

(72) Inventor: Wilhelm KLIEVER, Minden (DE)

(21) Appl. No.: 18/576,705

(22) PCT Filed: Jun. 23, 2022
(86) PCT No.: PCT/DE2022/100461

§ 371 Date: Jan. 4, 2024

(30) Foreign Application Priority Data
Jul. 5, 2021 (DE) 10 2021 117 220.9

(51) Int. Cl. H01M 50/298; H01M 50/262; H01M 50/271

(52) U.S. Cl. CPC H01M 50/298; H01M 50/262; H01M 50/271

(57) ABSTRACT

A module connection system for electrical energy storage systems includes at least two connection cover plates, at least two connection housings per connection cover plate, at least two cable fasteners, at least three cables and at least one sealing element. The connection cover plates each accommodate at least two connection contacts so that a connection can be established between at least two energy storage modules. The connection contacts are each surrounded by at least two connection fastenings which in tum are provided with connection housing fastenings for fastening the connection housing to a connection cover plate. The connection housings are also provided for accommodating a cable fastener and/or for accommodating a sealing element.

### BACKGROUND

### Technical Field

The present disclosure is based on a module connection system for energy storage systems. A connection housing for a module connection system is also provided.

Such module connection systems are required, for example, in order to connect together conductively modules of electrical energy storage systems. According to the present disclosure, the connection housings for these module connection systems permit a variability in the connection of the modules to one another or to the feed device and/or consumer device.

### Description of the Related Art

Energy storage systems, such as for electrical energy, are particularly popular, in particular due to the energy revolution. Energy storage systems are used both in the industrial sector and in the private sphere in order to store energy, for example, by photovoltaic systems for personal use. Such energy storage systems are generally of modular construction, i.e., a plurality of storage modules are installed in a control cabinet, which is disclosed, for example, in the document DE 10 2015 105 482 A1 and which is also denoted as a rack, and are electrically conductively connected to one another.

A drawback herein for the connection of the modules to one another is the relatively small amount of constructional space between the individual modules. Due to this small amount of constructional space, it is sometimes difficult to connect the conductors, which are designed as sheathed cables, for example, from an upper module to a module located directly below, and at the same time to shield them from contamination and/or fluids, such as water. Known solutions in the prior art generally provide the possibility of using a so-called cable gland. These cable glands, however, lengthen the module connection housing which makes assembly difficult, or even impossible in some cases, due to the aforementioned small amount of constructional space.

The German Patent and Trademark Office has researched the following prior art: DE 10 2014 012 320 B3 and CN 109 088 209 A in the priority application for the present application.

### BRIEF SUMMARY

Embodiments of the present disclosure provide a module connection system for the electrical connection of electrical energy storage systems, which permits variable fastening options and sealing options, such as relative to fluids in the liquid state. A further advantage of the disclosure is that a corresponding connection housing for the module connections of electrical energy storage systems is disclosed, the connection housing providing different fastening options for a module connection system and more than one sealing option.

A module connection system described herein for electrical energy storage systems may be described as having at least two connection cover plates, at least two connection housings per connection cover plate, at least two cable fasteners, at least three cables and at least one sealing element, wherein the connection cover plates each accommodate at least two connection contacts so that a connection can be established between at least two energy storage modules and wherein the connection contacts are each surrounded by at least two connection fastenings which in turn are provided with housing fastenings of the connection housings for fastening the connection housing to the respective connection cover plate, and wherein the connection housings are provided for accommodating a cable fastener and/or for accommodating a sealing element. “Electrical energy storage system” is understood to mean, in particular, fixed energy storage systems, for example for storing electrical energy from photovoltaic systems. Such electrical energy storage systems are generally constructed in the form of a control cabinet which is provided with different modules which are generally of the same construction.

These modules are connected to one another in the control cabinet in order to be able to achieve improved capacity. The term “connection cover plate” is understood to mean an element which is assembled in the energy storage system/control cabinet before an energy storage module, in order to shield the module from external influences and to present the connecting options clearly. “Cable fastener” is understood to mean strain relief devices, kink protection devices and, in particular, cable glands. These cable fasteners may be releasably connected to the connection housing. The term “connection housing” denotes a housing which can be releasably connected to the connection cover plate and which accommodates the connection contacts therein and protects against external influences, in particular contamination such as dust and liquid fluids, such as, for example, water. “Cables” are understood to mean sheathed or externally insulated electrical cables which are generally designed with one conductor but conceivably with a plurality of conductors. The term “sealing element” refers to protective sleeves which are additionally placed over a cable. Examples thereof are plastic hoses, fabric hoses or rubber hoses. “Connection fastening” is understood as means which permit a connection of the connection housing to the connection cover plates. Screws, bolts, interlocking latching hooks or bayonet closure elements can be used to this end. Other fastening means which can be used are known to a person skilled in the art.

A further embodiment provides that the connection housing may be designed in at least two parts, wherein the connection housings have at least one housing cover and one housing body, wherein the housing cover has at least one cover fastening which is brought into a connection with a corresponding body fastening of the housing body and wherein the housing cover and the housing body form a cavity for accommodating a power contact. For improved protection against contamination and water, it is proposed that a housing seal is arranged between the housing cover and the housing body. This housing seal can be cleverly incorporated in the housing cover and/or the housing body.

An alternative embodiment provides that the connection fastenings in cooperation with the housing fastenings may permit the orientation of each connection housing in at least three directions located in a common plane, wherein the plane is formed by the contact surface of the connection cover plate with the connection housings. In order to achieve an expedient seal against environmental influences, it is proposed to arrange a connection seal between the connection housing and the connection cover plate.

In an expedient embodiment, the connection housing has at least one thread for accommodating a cable fastener. As a result, for example, union nuts can be used with a sealing element in order to be used as a cable gland, whereby a connected cable is sufficiently sealed against foreign bodies and contamination.

In one embodiment, the connection housing may have an internal thread for accommodating a cable fastener. Thus the connection housing is designed for accommodating a cable gland with an external thread, so that a connected cable is sufficiently sealed against foreign bodies and contamination.

Moreover, one embodiment provides that the connection housing may have a cable outlet, wherein the cable outlet has at least one shaped fixing portion. In particular, a shaped fixing portion is understood to mean shaped elements which can accommodate an encompassing fastener, for example, in the form of a hose clip or a cable tie.

One embodiment also provides that the shaped fixing portion may be designed to prevent an encircling fastener from being released from the connection housing. In particular, one embodiment provides that the shaped fixing portion may be designed as a peripheral elevation on the connection housing. Alternatively, one embodiment provides that the shaped fixing portion may be designed as a peripheral recess on the connection housing. As a result, the aforementioned fasteners, for example cable ties, can be prevented from being inadvertently released from the connection housing. Some embodiments provide a connection housing, which is suitable for the module connection system, for the connection of at least one electrical conductor to a module of an energy storage system according to the above description, having at least one housing body and at least one housing cover, wherein the housing body and housing cover are designed to be able to be connected to one another and form a substantially sealed interior in the connected state, wherein the connection housing forms at least one cable outlet and wherein the cable outlet is designed to accommodate at least one cable fastener and additionally has at least one shaped fixing portion. “Cable fastener” is understood to mean fixing elements and sealing elements which are comparable to a cable gland. The shaped fixing portion is understood to mean shaped elements on the cable outlet which at least partially accommodate encompassing fixing elements, such as cable ties or hose clips, and thus prevent an inadvertent removal and/or release from the cable outlet.

### BRIEF DESCRIPTION OF THE SEVERAL VIEWS OF THE DRAWINGS

Embodiments of the disclosure are shown in the drawings and will be described in more detail hereinafter.

FIG. 1 shows a front view of a module connection system.

FIG. 2 shows a perspective view of two connected connection cover plates with the connection housings closed.

FIG. 3 shows a perspective view of two connected connection cover plates with the connection housings open.

FIG. 4 shows a perspective view of a connection cover plate with the connection housing.

FIG. 5 shows a perspective view of a connection cover plate with the connection housing and the visible connection contact.

The figures may contain partially simplified schematic views. In some cases, identical reference signs are used for elements which are similar but possibly not identical. Different views of the same elements could be scaled differently.

### DETAILED DESCRIPTION

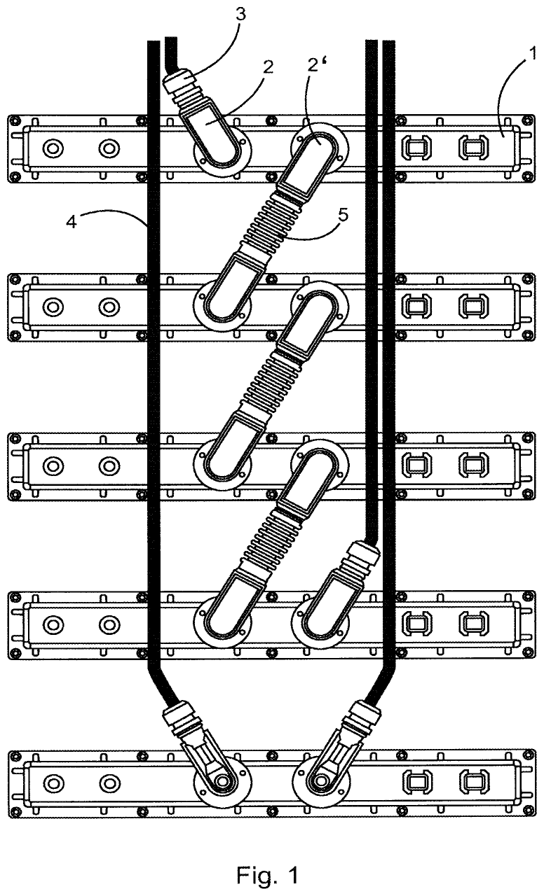

FIG. 1 shows a module connection system comprising a plurality of connection cover plates 1, which in each case are provided with at least two connection housings 2 and 2′. The connection housings 2 and 2′ shown in each case accommodate cables 4 and seal the transition of the cables 4 to connection contacts 10 of the energy storage modules (not shown) by cable fasteners 3, or in the case of the connection housing 2′, by a sealing element 5.

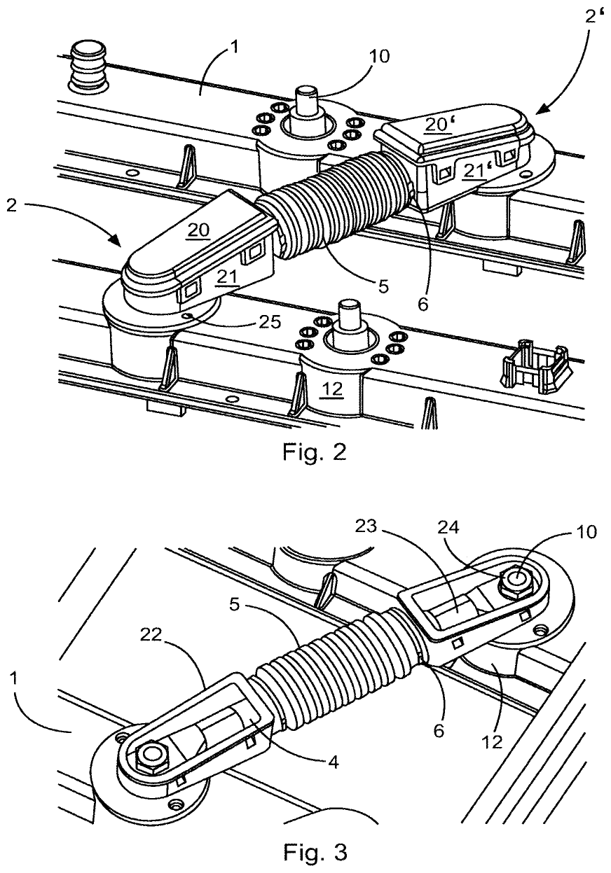

Two connection cover plates 1 are shown in detail in FIG. 2, wherein the main focus is on the connecting region of the connection contacts 10. Two of the four connection contacts 10 are clearly visible and protrude from the connection cover plates 1. In the region of the connection contacts 10 a deformation 12, in this case a bulge, can be identified above and below the connection contacts 10. Two connection contacts 10 are provided with a connection housing 2 and 2′, wherein the connection housings 2 and 2′ consist in each case of two components. These components are shown in the view as a housing cover 20 and 20′ and a housing body 21 and 21′. In the direction of the connection cover plate 1, the housing bodies 21 and 21′ have, around the outlet in the connection cover plate 1 for the connection contact 10, an approximately disk-shaped integrally formed portion with a through-opening for a housing fastening 25. The connection housing 2 and the connection housing 2′ can be fastened by the housing fastening 25 to the respective connection cover plate 1 by bolts, cotter pins, rivets, screws or similar fastener elements. The connection housings 2 and 2′ accommodate in each case one end of a cable 4 in the form of a sheathed cable which can be clearly identified in FIG. 3. The cable ends are provided in each case with a cable contact 23, as a crimp contact designed as a cable lug, with a bore for the connection contact 10, and fastened to the cable contacts 10 with a contact fastener 24, wherein in the case shown a nut is used for the fastening. It can also be identified in FIG. 2 and in FIG. 3 that the housing bodies 21 and 21′ accommodate the sealing element 5 which is fixed by sealing fasteners 6 to the housing bodies 21 and 21′. The sealing element 5 is a simple resilient rubber bellows in the example shown. Alternatively, a corrugated hose, a rubber hose or plastic hoses are conceivable and can provide positive effects.

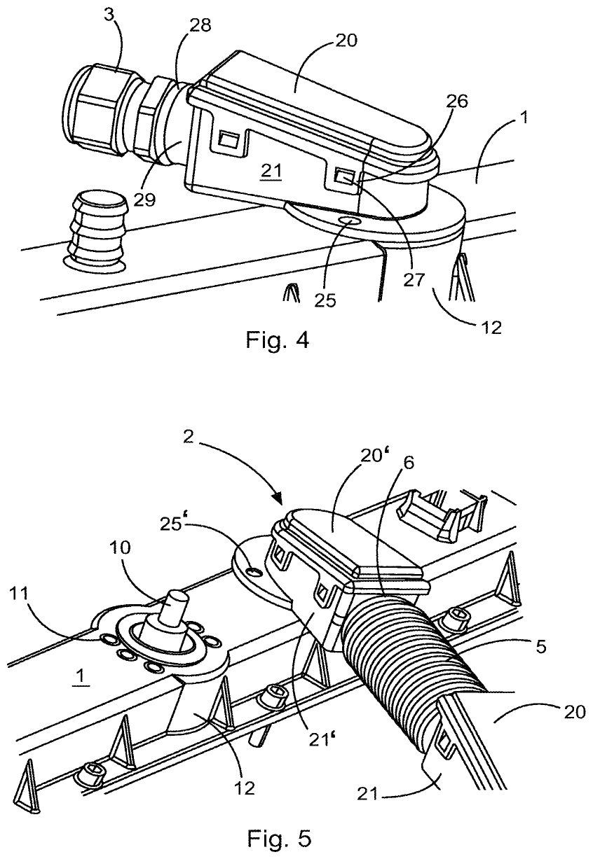

In FIG. 4 it is illustrated how the connection housing 2 can be expediently designed. As mentioned above, the connection housing 2 consists of the housing cover 20 and the housing body 21 which, for example, are connected together by an integrally formed fastening means. In the embodiment shown, the housing cover 20 has for each longitudinal side at least two cover fastenings 26 which are designed to be able to be connected to corresponding body fastenings 27 of the housing body 21. In the case shown, tabs with a suitable through-opening for the cover fastening 26 are used, while the housing body 21 is provided with relatively simple body fastenings 27 designed as latching hooks.

The housing body 21 also has a disk-shaped integrally formed portion which faces the connection cover plate 1 and which is designed with housing fastenings 25 provided as a through-opening. The housing fastenings 25 are located on either side of the housing body 21. In the case shown, the connection housing 2 can be fastened by simple screws to the corresponding connection cover plate 1. It is also clear that the housing body 21 has a cable outlet 29 at one end. This cable outlet 29 is designed with various means in order to accommodate both the cable fastener 3 and the sealing element 5. For the cable fastener 3, an internal thread is provided in the cable outlet 29 so that the cable fastener 3, which is designed as a cable gland, can be sealingly connected to the connection housing 2. The cable outlet 29 also has a shaped fixing portion 28, by way of example shown as a peripheral elevation or bead at the end of the cable outlet.

This shaped fixing portion 28 permits a particularly good fixing of a sealing element 5 to the respective connection housing 2, as is clear in FIG. 5. The sealing fastener 6, designed in the drawings as a hose clip or cable tie, can be attached simply, rapidly and cost-effectively to the cable outlet 29 by inserting the shaped fixing portion 28 after the assembly of the cables 4 and the sealing element 5 placed thereon. Here an inserted sealing element 5 is connected in a loss-proof manner to the cable outlet 29. The expedient use of the sealing element 5 is also explained in detail in FIG. 5. In the case of short distances, as occur for example with a connection of two energy storage modules arranged directly adjacent to one another/one below the other, the cable fastener 3 cannot be used in a meaningful way without complicating the assembly to an absurd degree.

FIGS. 1 and 5 indicate a further advantage of the module connection system. The connection cover plates 1 have a plurality of connection fastenings 11 around the connection contacts 10. These connection fastenings 11 are arranged such that the connection housing 2 can be fastened to the connection cover plate 1 in different orientations. With the design of six axisymmetrically arranged connection fastenings, the connection housing 2 with two correspondingly axisymmetrical housing fastenings 25 can be fastened in six orientations to the connection cover plate 1. In the example shown, the possible orientations are 0°, 30°, 150°, 180°, 210° and 330°.

While various aspects or features of the present disclosure are shown in each case in combination in the Figures, for a person skilled in the art-unless specified otherwise—it can be seen that the combinations shown and discussed are not the only possible ones. In particular, units or complexes of features corresponding to one another from the various embodiments can be exchanged with one another. In other words, aspects of the various embodiments described above can be combined to provide further embodiments.

In general, in the following claims, the terms used should not be construed to limit the claims to the specific embodiments disclosed in the specification and the claims, but should be construed to include all possible embodiments along with the full scope of equivalents to which such claims are entitled.

1. A module connection system for electrical energy storage systems, comprising:
at least two connection cover plates;
at least two connection housings per connection cover plate; at least two cable fasteners;
at least three cables; and
at least one sealing element, wherein the connection cover plates each accommodate at least two connection contacts so that a connection can be established between at least two energy storage modules, wherein the connection contacts are each surrounded by at least two connection fastenings which in turn are provided with housing fastenings of the connection housings for fastening the connection housing to the respective connection cover plate, and
wherein the connection housings are provided for accommodating the cable fastener and/or for accommodating the sealing element.

2. The module connection system as claimed in claim 1, wherein each connection housing is designed in at least two parts and has at least one housing cover and one housing body, wherein the housing cover has at least one cover fastening which is brought into a connection with a corresponding body fastening of the housing body, and wherein the housing cover and the housing body form a cavity for accommodating a power contact.

3. The module connection system as claimed in claim 1, wherein the connection fastenings in cooperation with the housing fastenings permit the orientation of each connection housing in at least three directions located in a common plane, wherein the common plane is formed by the contact surface of the connection cover plate with the connection housing.

4. The module connection system as claimed in claim 1, wherein the connection housing has at least one thread for accommodating a cable fastener.

5. The module connection system as claimed in claim 1, wherein the connection housing has an internal thread for accommodating a cable fastener.

6. The module connection system as claimed in claim 1, wherein the connection housing has a cable outlet, wherein the cable outlet has at least one shaped fixing portion.

7. The module connection system as claimed in claim 1, wherein the shaped fixing portion is designed to prevent an encircling fastener from being released from the connection housing.

8. The module connection system as claimed in claim 1, wherein the shaped fixing portion is designed as a peripheral elevation on the connection housing.

9. The module connection system as claimed in claim 1, wherein the shaped fixing portion is designed as a peripheral recess on the connection housing.

10. A connection housing for the connection of at least one electrical conductor to a module of an energy storage system, the connection housing comprising:
at least one housing body; and
at least one housing cover, wherein the housing body and the housing cover are designed to be able to be connected to one another and form a substantially sealed interior in the connected state, wherein the connection housing forms at least one cable outlet and wherein the cable outlet is designed to accommodate at least one cable fastener and has at least one shaped fixing portion.
